(19) United States
(12) Patent Application Publication
(10) Pub. No.: US 2025/0372318 A1
(43) Pub. Date: Dec. 4, 2025

(54) KEY TRAVEL ADJUSTABLE SWITCH

(71) Applicant: QANBA USA, LLC, Daly City, CA (US)

(72) Inventors: Kai LIU, Daly City, CA (US); Jeffrey LYO, Daly City, CA (US)

(21) Appl. No.: 18/890,582

(22) Filed: Sep. 19, 2024

(30) Foreign Application Priority Data
May 30, 2024 (CN) 202421205160.5

(51) Int. Cl. H01H 9/06; H01H 19/04; H01H 19/11; H01H 25/06

(52) U.S. Cl. CPC H01H 9/06; H01H 19/04; H01H 19/11; H01H 25/065

(57) ABSTRACT

Disclosed is a key travel adjustable switch, including a fastener, a switch cap connected to the fastener, a switch cap silicone positioned to connect to the switch cap and arranged between the switch cap and the fastener, and a switch body. The fastener is rotatable with a microswitch pin to trigger a microswitch, and the switch cap, the switch cap silicone, and the fastener form a rotary assembly. A travel positioning portion of the switch cap structurally matches with a plurality of travel adjusting portions on the switch body. A key travel of the key travel adjustable switch is adjustable by pressing and rotating the switch cap to match the travel positioning portion with different travel adjusting portions, thereby adjusting a response speed of the key travel adjustable switch to meet a user's demand.

### CROSS-REFERENCE TO RELATED APPLICATION(S)

The present application claims priority under 35 U.S.C § 119 to and the benefit of Chinese Patent Application No. 202421205160.5, filed on May 30, 2024, in China National Intellectual Property Administration, the entire disclosure of which is hereby incorporated herein by reference in its entirety.

### TECHNICAL FIELD

The present disclosure relates to the field of a switch, a game peripheral including the switch, and particularly relates to a rotary switch having an adjustable key travel.

### BACKGROUND

Most of current game keys and switches in the field of game peripherals have a single and fixed key travel. Keys and switches that adjust the key travel depending on drive on the market are tedious, and the key travel of such keys and es is not changed with a variation of a changed key travel to trigger an action or to change a state. Therefore, users have no intuitive feelings when using such keys and switches. With the development of electronic competitive games, the users have higher requirements and expectations to game peripherals, for example, a quick response to when pressing the game switches. However, existing game keys and switches cannot meet the high requirements of the users.

### SUMMARY

To solve the above problems, a first objective of the present disclosure is to provide a key travel adjustable switch. A second objective of the present disclosure is to provide a gaming peripheral including a key travel adjustable switch. A third objective of the present disclosure is to provide a method for adjusting a key travel adjustable switch.

The present disclosure achieves the above objectives by the following technical solutions:

In the first aspect, the present disclosure provides a key travel adjustable switch. The key travel adjustable switch may include a fastener, a switch cap connected to the fastener, a switch cap silicone positioned to connect to the switch cap and arranged between the switch cap and the fastener, and a switch body. The fastener may be rotatable with a microswitch pin to trigger a microswitch, and the switch cap, the switch cap silicone, and the fastener form a rotary assembly. The switch cap may match with a plurality of travel adjusting portions on the switch body through a travel positioning portion of the switch cap that structurally fits a travel adjusting portion of the plurality of travel adjusting portions. A key travel of the key travel adjustable switch may be adjustable by pressing and rotating the switch cap to match the travel positioning portion with different travel adjusting portions among the plurality of travel adjusting portions.

In one or more embodiments, the switch cap may include a body, and the travel positioning portion, a clamping board, and a positioning groove may be formed in an edge of the body of the switch cap.

In one or more embodiments, a positioning protrusion may be formed at a side edge of the silicone, and the positioning protrusion may match with the positioning groove for keeping the silicone positioned and rotated with the switch cap, and a compressing portion may be arranged below the silicone for abutting against the microswitch pin connected to the fastener.

In one or more embodiments, the fastener may include a clamping protrusion, and the clamping protrusion may be connected to a clamping hole in the clamping board.

In one or more embodiments, a mounting hole that matches with the microswitch pin may be formed in the middle of the fastener, a rotation limiting groove is formed at a peripheral side of the mounting hole, a pin clamping foot may be arranged on the microswitch pin, the pin clamping foot may match with the rotation limiting groove and may be rotated relatively to the rotation limiting groove, and the microswitch pin may be fixedly connected to a microswitch.

In one or more embodiments, the body of the switch cap may be made of a transparent material, and a ring may be arranged at an upper edge of the switch body, a plurality of position indicators may be arranged at the ring to indicate corresponding key travels of the switch, and a direction of the positioning protrusion of the silicone may indicate a corresponding position indicator among the plurality of position indicators.

In one or more embodiments, the travel positioning portion formed on the body of the switch cap may be a clamping foot, and the plurality of travel adjusting portions on the switch body may be a plurality of slots of different heights, an avoiding groove may be formed below the plurality of slots. By pressing and rotating the switch cap, the clamping foot of the switch cap may be moved from a first slot of the plurality of slots to a second slot of the plurality of slots.

In one or more embodiments, a number of the plurality of slots may be 3, and each slot of the plurality of slots may be of a height that is different from the others.

In one or more embodiments, a silicone gasket may be further arranged in the switch body.

In one or more embodiments, the key travel may range from 0.1 mm to 3 mm.

In the second aspect, the present disclosure provides a gaming peripheral including the key travel adjustable switch described above.

In the third aspect, the present disclosure provides a method for adjusting the key travel adjustable switch described above. In one or more embodiments, the method may include matching the switch cap with a first travel adjusting portion of the plurality of travel adjusting portions on the switch body through the travel positioning portion of the switch cap, and pressing and rotating the switch cap to match the travel positioning portion with a second travel adjusting portion of the plurality of travel adjusting portions to adjust the key travel of the key travel adjustable switch.

The present disclosure has the following beneficial effects: the switch cap, the silicone, and the fastener may form the rotary assembly. By pressing and rotating the switch cap, the key travel of the key travel adjustable switch can be adjusted, so as to adjust a response speed of the key travel adjustable switch to meet a user's demand.

### BRIEF DESCRIPTION OF FIGURES

In order to describe the embodiments of the present disclosure or the technical solutions in the prior art more clearly, brief introduction on drawings needed to be used in the embodiments will be made below. Apparently, the drawings described below are some embodiments of the present disclosure, and a person skilled in the technical field further can obtain other drawings according to the drawings without making creative efforts.

FIG. 1 is a front view of the switch of the present disclosure;

FIG. 2 is an A-A section view of FIG. 1;

FIG. 3 is an axonometric drawing of FIG. 1;

FIG. 4 is an exploded view of the switch of the present disclosure;

FIG. 5 is a diagram showing structural matching of a fastener and a microswitch pin of the present disclosure;

FIG. 6 is a front view showing structural matching of a switch cap, the fastener, and the microswitch pin of the present disclosure;

FIG. 7 is an axonometric drawing of FIG. 6; and

FIG. 8 is a three-dimensional view of silicone of the present disclosure.

### LIST OF REFERENCE NUMERALS

1: switch cap; 101: body of switch cap; 102: clamping board; 103: travel positioning portion; 104: positioning groove; 2: silicone; 201: compressing portion; 202: positioning protrusion; 3: switch body; 301: travel adjusting portion; 302: avoiding groove; 4: fastener; 401: clamping protrusion; 402: rotation limiting groove; 5: microswitch pin; 501: pin clamping foot; 6: silicone gasket; 7: microswitch; 8: ring; and 9: position indicator.

### DETAILED DESCRIPTION

In order to make objectives, technical solutions and advantages of the present disclosure clearer, the technical solutions of the present disclosure will be further described in detail below. The described embodiments are merely example embodiments of the present disclosure and are not all the embodiments. On the basis of the embodiments in the present disclosure, all other implementations obtained by a person of ordinary skill in the art without creative efforts fall into the scope of protection of the present disclosure.

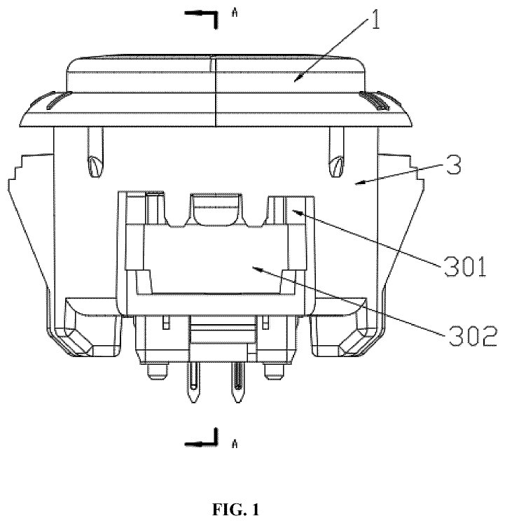

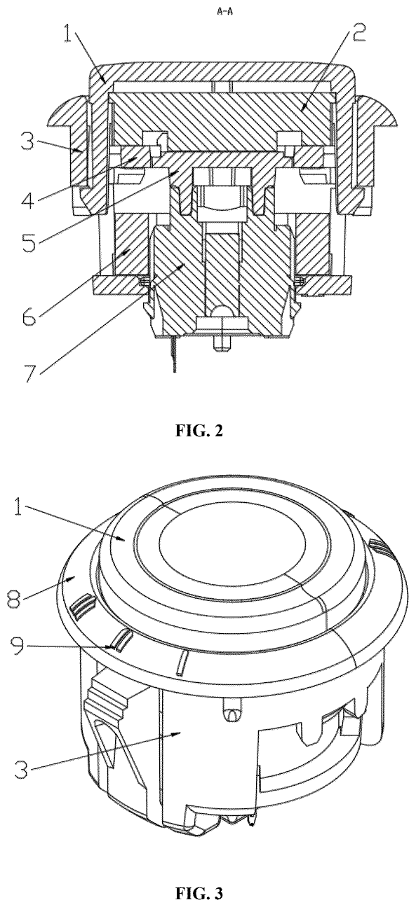

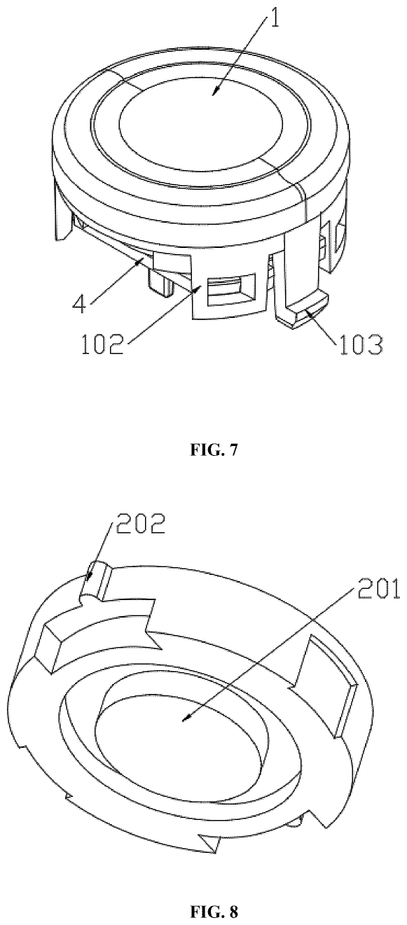

Referring to FIGS. 1 to 8, the present disclosure provides a switch having an adjustable key travel (sometimes hereinafter referred to as adjustable switch). The switch may include a switch cap 1, a switch cap silicone 2, a fastener 4, a switch body 3, a microswitch pin 5, and a silicone gasket 6. As used herein, the term “switch” may be a key, a button or a switch that is actuated/triggered to change its state. A switch actuation of the switch may be occurred by any suitable physical interaction with the switch which may cause a mechanical linkage inside the switch to come into, or go out of, contact. For example, a physical interaction may be pushing, sliding, rotating, pulling, heating, and/or magnetizing. In one or more embodiments, the switch may be a magnetic switch, a capacitive switch, and a hall effect switch. In one or more embodiments, the switch may be a momentary push-down switch. The switch cap 1 may be connected to the fastener 4, for example, the switch cap 1 may be snapped to the fastener 4. The switch cap silicone 2 may be arranged between a body of the switch cap 101 and the fastener 4, and the switch cap silicone 2 may be positioned to connect to the switch cap 1, e.g., the switch cap silicone 2 may be positioned to fit to the switch cap 1. The fastener 4 may be rotated to trigger a microswitch pin 5, and the switch cap 1, the switch cap silicone 2, and the fastener 4 may form a rotary assembly. The switch cap 1 may match with a plurality of travel adjusting portions 301 on the switch body 3 through a travel positioning portion 103 of the switch cap 1. For example, the travel positioning portion 103 may structurally fit a travel adjusting portion 301 of the plurality of travel adjusting portions 301. By pressing and rotating the switch cap 1, the travel positioning portion 103 may be moved to match with different travel adjusting portions 301 to adjust an adjustable key travel of the switch. The microswitch pin 5 may be connected to a microswitch 7, which is utilized to trigger an action of a switch (e.g., changing a state of the switch) through a predetermined travel distance and/or a predetermined force. In one or more embodiments, the microswitch 7 may be called as a sensitive switch or a snap switch because a separation to a trigger contact of the microswitch is relatively small.

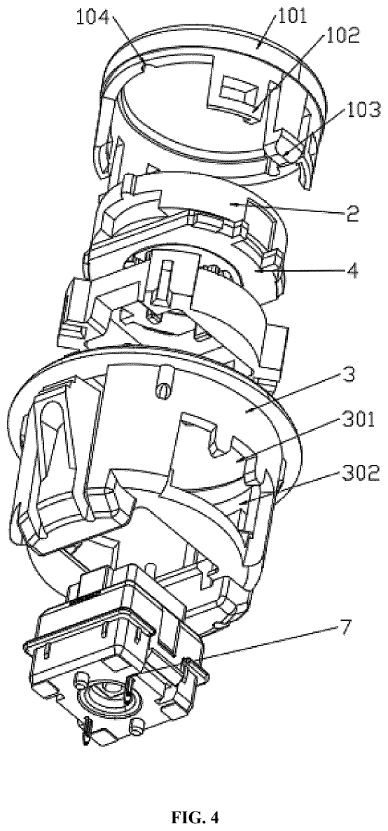

In one embodiment of the present disclosure, as shown in the structure of the switch cap 1 in FIG. 4, the switch cap 1 may include a body of the switch cap 101, and the body of the switch cap 101 may be made of a transparent material, for example, transparent silicone. The travel positioning portion 103 and a clamping board 102 may be formed at an edge of the body of the switch cap 101, and a positioning groove 104 may be formed in the edge of the body of the switch cap 101. Two travel positioning portions 103 may be symmetrically arranged at the edge of the body of the switch cap 101. Two clamping boards 102 may be arranged on each side of each of the travel positioning portions 103, so that the switch cap 1 may match/fit with the travel adjusting portion 301 on the switch body 3 stably. A clamping hole that matches with a clamping protrusion 401 on the fastener 4 may be formed in the clamping board 102, so that the switch cap 1 may match with the fastener 4 stably.

Furthermore, in one embodiment of the present disclosure, as shown in FIG. 8, a positioning protrusion 202 may be formed at a side edge of the switch cap silicone 2, and the positioning protrusion 202 may match with the positioning groove 104 of the switch cap 1. A compressing portion 201 may be arranged below the switch cap silicone 2 for abutting against the microswitch pin 5 connected to the fastener 4. The positioning protrusion 202 not only may be able to make the switch cap silicone 2 positioned and fitted to the switch cap 1, but also may indicate a corresponding position indicator 9 which may be used to adjust the adjustable key travel.

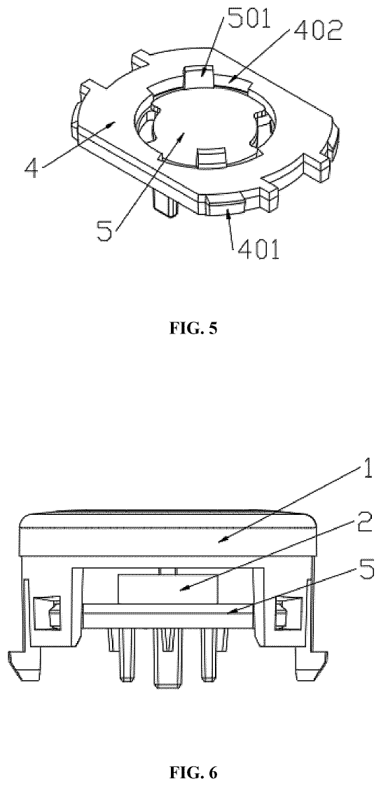

As shown in FIG. 5, the fastener 4 may include a clamping protrusion 401, and the clamping protrusion 401 may be connected to a clamping hole in the clamping board 102. For example, the clamping protrusion 401 may be snapped to the clamping board 102. The switch cap 1 and the switch cap silicone 2 may match with the fastener 4 to form the rotary assembly which may be rotated to adjust the adjustable key travel. A mounting hole that matches with the microswitch pin 5 may be formed in the middle of the fastener 4, a rotation limiting groove 402 may be formed in a peripheral side of the mounting hole, a pin clamping foot 501 may be arranged on the microswitch pin 5, and the pin clamping foot 501 may match with the rotation limiting groove 402 and may be rotated relatively to the rotation limiting groove 402. For example, the pin clamping foot 501 may be slid within the rotation limiting groove 402. When the switch is in use, the microswitch pin 5 may be fixedly connected to a microswitch 7, and the switch cap 1, the switch cap silicone 2, and the fastener 4 may be rotated as the rotary assembly. In one or more embodiments, two rotation limiting grooves 402 and two pin clamping feet which match correspondingly may be provided. The compressing portion 201 below the switch cap silicone 2 may abut against an upper surface of the microswitch pin 5 to keep the rotation stable.

As shown in FIG. 3, to order to display the position indicators 9 conveniently, a ring 8 may be arranged at an upper edge of the switch body 3, a plurality of different position indicators 9 may be arranged at the ring 8, and the positioning protrusion 202 at the side edge of the switch cap silicone 2 may indicate at a corresponding position indicator 9. In one embodiment, the ring 8 may be an edge in a shape of a hat brim, or an annular shape.

In one embodiment of the present disclosure, the travel positioning portion 103 formed on the body of the switch cap 101 may be a clamping foot. The travel adjusting portions 301 arranged on the switch body 3 may be a plurality of slots of different heights, an avoiding groove 302 may be formed below the plurality of slots. By pressing and rotating the switch cap 1, the clamping foot of the switch cap 101 may be separated from the slots and may be rotated to a different slot. In one or more embodiments, three slots may be provided with different heights, that is, the switch may provide three adjustable key travels corresponding to the three position indicators 9.

Furthermore, a silicone gasket 6 may be further arranged in the switch body 3, which improves the hand feeling of the switch.

Furthermore, the adjustable key travel may range from 0.1 mm to 3 mm. The adjustable key travel may be a distance that the switch cap 1 is moved downwards after being pressed. In one or more embodiments, the adjustable key travel may range from 0.5 mm to 1.5 mm, more specifically, the adjustable key travel may range from 0.8 mm to 1.2 mm. For example, three adjustable key travels may be provided within a distance ranging from 0.8 mm to 1.2 mm, that is, the switch may have a first key travel of 0.8 mm, a second key travel of 1.0 mm, and a third key travel of 1.2 mm.

Furthermore, a number of the plurality of travel adjusting portions 301 may be from 2 to 10.

Furthermore, the adjustable switch of the present disclosure may be a keyboard key, a gamepad switch, or an arcade game switch.

The present disclosure provides a game peripheral, including the above adjustable switch.

The present disclosure further provides a method for adjusting the above adjustable switch. In one or more embodiments, the method may include forming the rotary assembly using the switch cap, the switch cap silicone, and the fastener, matching the switch cap with the plurality of travel adjusting portions on the switch body through one travel positioning portion of the switch cap that structurally fits the travel adjusting portion of the plurality of travel adjusting portions, and pressing and rotating the switch cap to match the travel positioning portion with different travel adjusting portions among the plurality of travel adjusting portions to adjust the key travel of the switch.

The above is merely the specific implementations of the present disclosure and is not intended to limit the scope of protection of the present disclosure. Any variations or replacements apparent to a person skilled in the art within the technical scope disclosed by the present disclosure shall fall within the scope of protection of the present disclosure. Therefore, the scope of protection of the present disclosure shall be subject to the scope of protection of the claims.

What is claimed is:

1. A key travel adjustable switch, comprising:
a fastener;
a switch cap connected to the fastener;
a switch cap silicone positioned to connect to the switch cap and arranged between the switch cap and the fastener; and
a switch body,
wherein the fastener is rotatable with a microswitch pin to trigger a microswitch, and the switch cap, the switch cap silicone, and the fastener form a rotary assembly,
wherein the switch cap matches with a plurality of travel adjusting portions on the switch body through a travel positioning portion of the switch cap that structurally fits a travel adjusting portion of the plurality of travel adjusting portions, and
wherein a key travel of the switch is adjustable by pressing and rotating the switch cap to match the travel positioning portion with different travel adjusting portions among the plurality of travel adjusting portions.

2. The key travel adjustable switch according to claim 1, wherein the switch cap comprises a body, and the travel positioning portion, a clamping board, and a positioning groove are at an edge of the body of the switch cap.

3. The key travel adjustable switch according to claim 2, wherein a positioning protrusion is at a side edge of the switch cap silicone, and the positioning protrusion matches with the positioning groove for keeping the switch cap silicone positioned and rotated with the switch cap, and a compressing portion is arranged below the switch cap silicone for abutting against the microswitch pin connected to the fastener.

4. The key travel adjustable switch according to claim 3, wherein the fastener comprises a clamping protrusion, and the clamping protrusion is connected to a clamping hole in the clamping board.

5. The key travel adjustable switch according to claim 2, wherein a mounting hole that matches with the microswitch pin is formed in the middle of the fastener, a rotation limiting groove is formed at a peripheral side of the mounting hole, a pin clamping foot is arranged on the microswitch pin, the pin clamping foot matches with the rotation limiting groove and is rotated relatively to the rotation limiting groove, and the microswitch pin is fixedly connected to the microswitch.

6. The key travel adjustable switch according to claim 3, wherein a ring is arranged at an upper edge of the switch body, a plurality of position indicators is arranged at the ring to indicate corresponding key travels of the switch, and a direction of the positioning protrusion of the switch cap silicone indicates a corresponding position indicator among the plurality of position indicators.

7. The key travel adjustable switch according to claim 2, wherein the travel positioning portion formed on the body of the switch cap is a clamping foot; and
the plurality of travel adjusting portions on the switch body is a plurality of slots of different heights, an avoiding groove is formed below the plurality of slots, and by pressing and rotating the switch cap, the clamping foot of the switch cap is moved from a first slot of the plurality of slots to a second slot of the plurality of slots.

8. The key travel adjustable switch according to claim 7, wherein a number of the plurality of slots is 3, and each slot of the plurality of slots is of a height that is different from the others.

9. The key travel adjustable switch according to claim 7, wherein a silicone gasket is further arranged in the switch body.

10. The key travel adjustable switch according to claim 1, wherein the adjustable key travel ranges from 0.1 mm to 3 mm.

11. A gaming peripheral, comprising a key travel adjustable switch, wherein the key travel adjustable switch comprises:
a fastener;
a switch cap connected to the fastener;
a switch cap silicone positioned to connect to the switch cap and arranged between the switch cap and the fastener; and
a switch body,
wherein the fastener is rotatable with a microswitch pin to trigger a microswitch, and the switch cap, the switch cap silicone, and the fastener form a rotary assembly,
wherein the switch cap matches with a plurality of travel adjusting portions on the switch body through a travel positioning portion of the switch cap that structurally fits a travel adjusting portion of the plurality of travel adjusting portions, and
wherein a key travel of the switch is adjustable by pressing and rotating the switch cap to match the travel positioning portion with different travel adjusting portions among the plurality of travel adjusting portions.

12. The gaming peripheral according to claim 11, wherein the switch cap comprises a body, and the travel positioning portion, a clamping board, and a positioning groove are formed at an edge of the body of the switch cap.

13. The gaming peripheral according to claim 12, wherein a positioning protrusion is formed at a side edge of the switch cap silicone, and the positioning protrusion matches with the positioning groove for keeping the switch cap silicone positioned and rotated with the switch cap, and a compressing portion is arranged below the switch cap silicone for abutting against the microswitch pin connected to the fastener.

14. The gaming peripheral according to claim 13, wherein the fastener comprises a clamping protrusion, and the clamping protrusion is connected to a clamping hole in the clamping board.

15. The gaming peripheral according to claim 12, wherein a mounting hole that matches with the microswitch pin is formed in the middle of the fastener, a rotation limiting groove is formed at a peripheral side of the mounting hole, a pin clamping foot is arranged on the microswitch pin, the pin clamping foot matches with the rotation limiting groove and is rotated relatively to the rotation limiting groove, and the microswitch pin is fixedly connected to a microswitch.

16. The gaming peripheral according to claim 13, wherein a ring is arranged at an upper edge of the switch body, a plurality of position indicators is arranged at the ring to indicate corresponding key travels of the key travel adjustable switch, and a direction of the positioning protrusion of the switch cap silicone indicates a corresponding position indicator among the plurality of position indicators.

17. The gaming peripheral according to claim 12, wherein the travel positioning portion formed on the body of the switch cap is a clamping foot; and
the plurality of travel adjusting portions on the switch body is a plurality of slots of different heights, an avoiding groove is formed below the plurality of slots, and by pressing and rotating the switch cap, the clamping foot of the switch cap is moved from a first slot of the plurality of slots to a second slot of the plurality of slots.

18. The gaming peripheral according to claim 17, wherein a number of the plurality of slots is 3, and each slot of the plurality of slots is of a height that is different from the others.

19. The gaming peripheral according to claim 17, wherein a silicone gasket is further arranged in the switch body.

20. A method for adjusting a key travel adjustable switch, wherein the key travel adjustable switch comprises:
a fastener;
a switch cap connected to the fastener;
a switch cap silicone positioned to connect to the switch cap and arranged between the switch cap and the fastener; and
a switch body,
wherein the fastener is rotatable with a microswitch pin to trigger a microswitch, and the switch cap, the switch cap silicone, and the fastener form a rotary assembly,
wherein the switch cap matches with a plurality of travel adjusting portions on the switch body through a travel positioning portion of the switch cap that structurally fits a travel adjusting portion of the plurality of travel adjusting portions, and
wherein a key travel of the switch is adjustable by pressing and rotating the switch cap to match the travel positioning portion with different travel adjusting portions among the plurality of travel adjusting portions, and
the method comprising:
matching the switch cap with a first travel adjusting portion of the plurality of travel adjusting portions on the switch body through the travel positioning portion of the switch cap; and
pressing and rotating the switch cap to match the travel positioning portion with a second travel adjusting portion of the plurality of travel adjusting portions to adjust the key travel of the key travel adjustable switch.
